(19) United States
(12) Patent Application Publication
(10) Pub. No.: US 2004/0146273 A1
(43) Pub. Date: Jul. 29, 2004

(54) Video recording/reproducing apparatus

(76) Inventor: Kanji Imanishi, Osaka (JP)

Correspondence Address: OSHA & MAY L.L.P., 1221 MCKINNEY STREET, HOUSTON, TX, 77010, US

(21) Appl. No.: 10/753,624

(22) Filed: Jan. 8, 2004

(30) Foreign Application Priority Data
Jan. 9, 2003 (JP) 2003-003154 (P)

(51) Int. Cl. H04N 5/76; H04N 5/781

(52) U.S. Cl. 386/46; 386/125

(57) ABSTRACT

A video recording/reproducing apparatus includes a recording system for inputting video information via an input unit and successively recording and accumulating the input information in an HDD, and a reproducing system for reading the information in the order of input from the HDD for the purpose of reproducing the information to output an image via an output unit. In the recording system, the input information is successively recorded in a buffer which allows a higher writing/reading relative to the HDD, temporarily stored in the buffer, and then read from the buffer in the order to input to be processed and written to the HDD. For a live reproduction, if a CPU determines that information to be reproduced is recorded in the buffer, the CPU controls an AVSW (audio-visual switch) to switch it for reading the information not from the HDD but from the buffer and output the information to the output unit.

### BACKGROUND OF THE INVENTION

1. Field of the Invention

The present invention relates to a video recording/reproducing apparatus for recording information including a video and reproducing the recorded information. In particular, the present invention relates to a video recording/reproducing apparatus for recording/reproducing video information through a recording unit.

2. Description of the Background Art

Japanese Patent Laying-Open Nos. 2002-51290, 10-208392 and 2002-170319 disclose image recording/reproducing apparatuses with a time shifting function for television broadcasts. The time shifting function allows two different operations to be performed in parallel, namely, an operation of converting a received broadcast signal into digital information to record the information on such a recording unit as a randomly-accessible hard disk and an operation of reading the recorded information to output an image corresponding to the broadcast signal via such an output unit as a television receiver.

The above-described conventional image recording/reproducing apparatuses record, on the recording unit, video information based on a broadcast signal which is received when the power is turned on and simultaneously read (reproduce) information from the recording unit for watching purposes. Therefore, a resultant video being watched is not a video which is directly derived from the broadcast signal received at the power-on timing but a video derived from a broadcast signal which is received and then recorded temporarily on the recording unit and thereafter reproduced. As a result, the video being watched has a delay of a certain time (e.g. three seconds) relative to a video which is directly derived from the broadcast signal received. Moreover, since the video being watched has undergone signal-processing for recording and reproducing on and from the recording unit, the quality of the video is inevitably degraded.

### SUMMARY OF THE INVENTION

An object of the present invention is to provide a video recording/reproducing apparatus capable of reducing time delays and image-quality degradations of a video.

In order to achieve the object above, a video recording/reproducing apparatus according to an aspect of the present invention includes a recording system for inputting information including at least a video and successively recording and accumulating the input information in a recording unit, and a reproducing system for reading the information in the order of input from the recording unit for the purpose of reproducing the information. The recording system includes a temporary recording unit for temporarily recording the input information successively before the recording unit records the input information, and the information recorded by the temporary recording unit is read therefrom, in the order of input, to be recorded in the recording unit. If the information to be reproduced is recorded in the temporary recording unit, the reproducing system reads the information to be reproduced from the temporary recording unit instead of the recording unit.

In the video recording/reproducing apparatus as described above, the recording system inputs the information including at least a video, temporarily records the information in the temporary recording unit and thereafter reads the information to record and accumulate the read information in the recording unit. If information to be reproduced is recorded in the temporary recording unit, the reproducing system reads the information not from the recording unit but from the temporary recording unit for the purpose of reproducing the information.

When information to be reproduced is recorded in the temporary recording unit, the reproducing system thus reads the information from the temporary recording unit, not from the recording unit, i.e., the information to be reproduced is read via the temporary recording unit only. Therefore, any time delay between information reproduced while inputting and recording the information in a recording unit and input information can be reduced. Moreover, in such a case where the information is read without being passed through the recording unit, any loss in information amount that could occur if the information is passed through the recording unit as well as occurrence of noise can be avoided, so that a reproduced image of good quality can be obtained.

Preferably, the reproducing system of the video recording/reproducing apparatus includes a switch unit for selecting and outputting, as the information to be reproduced, one of the information read from the temporary recording unit and the information read from the recording unit, and a determination unit for determining whether the information to be reproduced is recorded in the temporary recording unit or the recording unit.

The switch unit selects and outputs the information read from the temporary recording unit if the determination unit determines that the information to be reproduced is recorded in the temporary recording unit, and the switch unit selects and outputs the information read from the recording unit if the determination unit determines that the information to be reproduced is recorded in the recording unit.

In this way, it is determined that whether information to be reproduced by the reproducing system is still recorded in the temporary recording unit or read from the temporary recording unit and recorded in the recording unit and, according to the result of the determination, the switch unit is switched. Thus, the information to be reproduced can selectively be output from the temporary recording unit or the recording unit.

Preferably, the determination unit of the video recording/reproducing apparatus determines that the information to be reproduced is recorded in the temporary recording unit if there is no time difference between the information to be reproduced and the input information.

In this way, the determination unit can determine, from the fact that there is no time difference between the information to be reproduced and the input information, that the information to be reproduced is recorded in the temporary recording unit.

Preferably, the determination unit of the video recording/reproducing apparatus determines that the information to be reproduced is recorded in the recording unit if there is at least a predetermined time difference between the information to be reproduced and the input information and determines that the information to be reproduced is recorded in the temporary recording unit if there is less than the predetermined time difference between the information to be reproduced and the input information.

In this way, the determination unit can determine, from the fact that there is less than a predetermined time difference between information to be reproduced and input information, that the information to be reproduced is recorded in the temporary recording unit. Further, the determination can determine, from the fact that there is at least the predetermined time difference between information to be reproduced and input information, that the information to be reproduced is not recorded in the temporary recording unit but in the recording unit.

Preferably, for the video recording/reproducing apparatus, the predetermined time difference corresponds to a time period in which the information is temporarily recorded in the temporary recording unit. Thus, information to be reproduced can be the information recorded and still held in the temporary recording unit.

Preferably, the temporary recording unit of the video recording/reproducing apparatus has a recording capacity corresponding to an information amount corresponding to the predetermined time difference. Information to be reproduced can thus be the information which has been recorded in the temporary recording unit and is still held therein.

Preferably, the reproducing system of the video recording/reproducing apparatus further includes a resume unit for resuming, after a reproduction is paused, the reproduction by canceling pausing of the reproduction, and the predetermined time difference corresponds to a time period in which the reproduction is paused.

Thus, when a reproduction is resumed after being paused, information to be reproduced can selectively be read from one of the temporary recording unit and the recording unit that records the information to be reproduced, according to the length of the pause period.

Preferably, the reproducing system of the video recording/reproducing apparatus further includes a resume unit for resuming, after a rewind is done in a reproduction, the reproduction by canceling the rewind, and the predetermined time difference corresponds to a time period corresponding to information for which the rewind is done.

When a rewind is done in a reproduction and thereafter the reproduction is resumed, information to be reproduced can selectively be read from one of the temporary recording unit and the recording unit that records the information to be reproduced, according to the length of time corresponding to information for which the rewind is done.

Preferably, the input information including the video is information based on a received live broadcast. Thus, the characteristics derived from the above-described structure can be obtained for information from a live broadcast being received.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a video recording/reproducing apparatus according to an embodiment of the present invention.

FIG. 2 is a flowchart for an operation of the video recording/reproducing apparatus according to the embodiment of the present invention.

FIGS. 3A-3C respectively show states of the video recording/reproducing apparatus for switching the path over which data is transmitted to be output, according to the embodiment of the present invention.

FIG. 4 is a timing chart illustrating switching of an audio-video switch (AVSW) according to the embodiment of the present invention.

### DESCRIPTION OF THE PREFERRED EMBODIMENTS

An embodiment of the present invention is hereinafter described in connection with the drawings. Information to be recorded/reproduced that is herein described is video information only for the purpose of facilitating description. However, information of other types (e.g. audio information) which can be input in parallel with video information may be recorded/reproduced in parallel with the video information. Further, although information to be recorded/reproduced is herein received via an antenna for example, the information may be received from an external unit through wires/cables for example. In other words, the route through which information to be recorded is supplied is not limited.

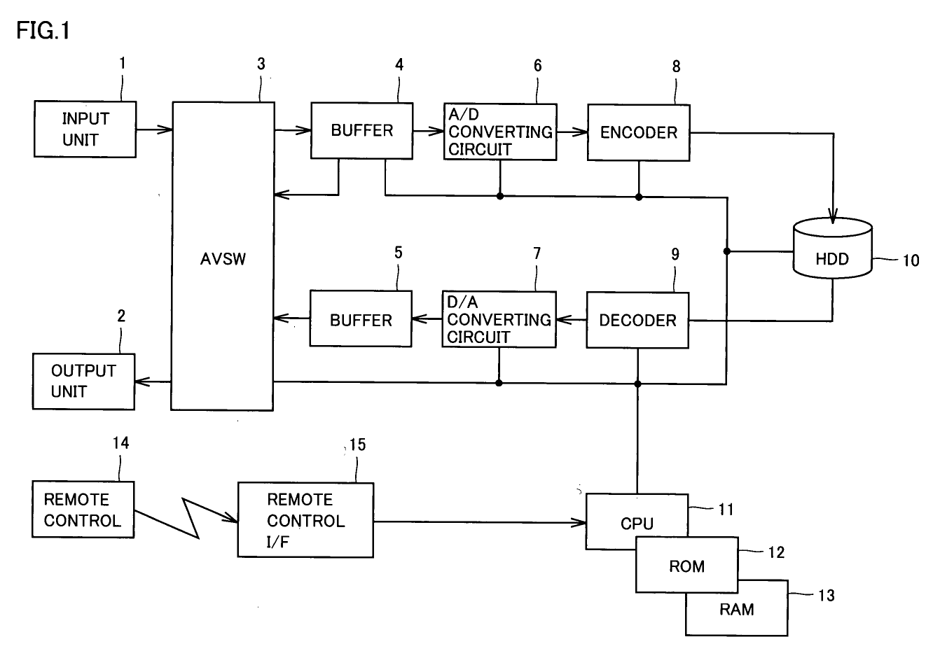

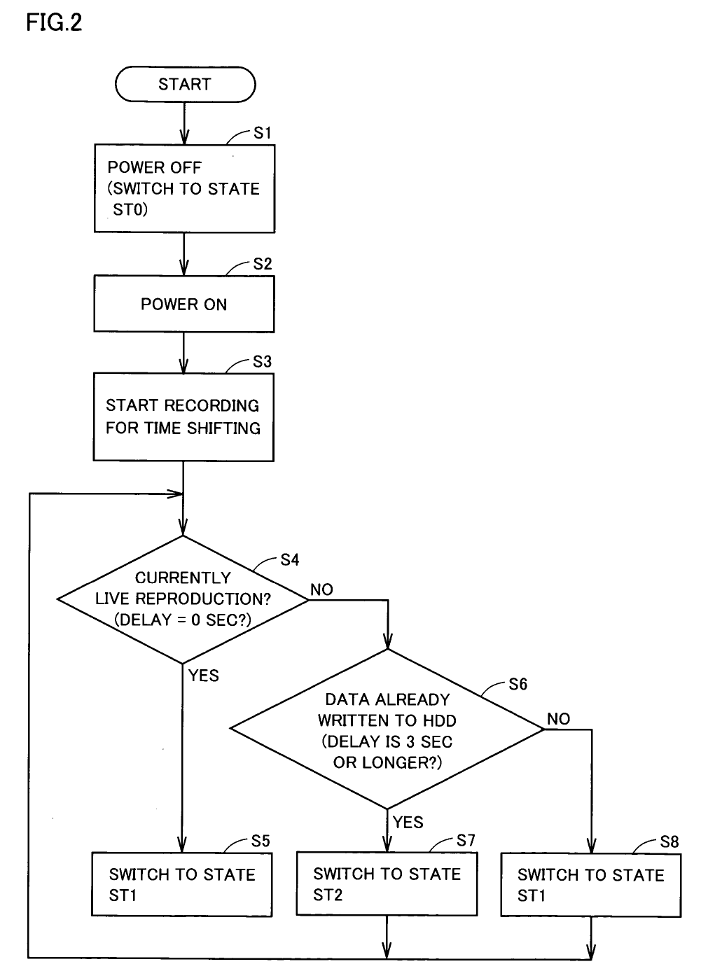

FIG. 1 shows a structure of a video recording/reproducing apparatus according to this embodiment of the present invention. FIG. 2 shows a flowchart for an operation of the video recording/reproducing apparatus.

Referring to FIG. 1, the video recording/reproducing apparatus includes an input unit 1 extracting video information for a program corresponding to a desired channel from an analog video signal received for example via an antenna (not shown), an output unit 2 receiving analog video information which is input thereto to output the information onto a monitor of a television receiver (not shown) for example, an AVSW (Audio-Visual Switch) 3 having a switching function for information to be provided to output unit 2, and buffers 4 and 5 each capable of storing a predetermined amount of information, i.e., information corresponding to a predetermined period of time, and the buffers temporarily store video information successively that is provided and input thereto to output the information in the order of input. The video recording/reproducing apparatus further includes an A/D (Analog-Digital) converting circuit 6 converging analog information provided thereto into digital information, a D/A (Digital-Analog) converting circuit 7 converting digital video information provided thereto into analog information, an encoder 8 encoding a provided digital video through a predetermined procedure to output the resultant video, a decoder 9 decoding digital video information provided thereto through a predetermined procedure to output the resultant information, an HDD (Hard Disk Driver) 10 to which the video information from encoder 8 is input, and which writes and accumulates (stores) the information in the order of input in a recording area and reads and outputs, in the order of input, video information which has already been written to the recording area, and a CPU (Central Processing Unit) 11 intensively controlling and monitoring respective components in the apparatus. The video recording/reproducing apparatus further includes a ROM (Read-Only Memory) 12 and a RAM (Random-Access Memory) 13 for storing programs and data for example concerning processing by CPU 11, a remote control 14 handled by a user for example for providing such information as instructions to the apparatus, and a remote control I/F (Interface) 15 to which information is input from remote control 14 and which outputs the information to CPU 11.

Buffers 4 and 5 are memories capable of performing faster reading and faster writing as compared with HDD 10, and a switch is made quickly between the reading and the writing that are done by turns in terms of time.

Arrows shown between components in FIG. 1 indicate a flow of data and lines without arrows shown between components indicate a flow of information including commands between CPU 11 and corresponding components.

Upon power-on of the video recording/reproducing apparatus shown in FIG. 1, analog video information is output from input unit 1. Then, in parallel with output of video information to output unit 2, the video information which is output from input unit 1 is written to HDD 10 for performing the time shifting function. The video information is written by a recording system. The video information which is output from input unit 1 is thus written to HDD 10, and the video information is thereafter read by a reproducing system for being reproduced. These operations are now specifically described.

In the recording system, analog video information input by and output successively from input unit 1 is passed through AVSW 3, written to buffer 4 in the order of input, temporarily stored therein, and thereafter read therefrom in the order of input. The capacity of buffer 4 is limited to a predetermined capacity. Therefore, when video information of an amount corresponding to the predetermined capacity, i.e., a predetermined time period, has been written, the written video information is read in the order of input (being written). During the reading operation, new video information is written to buffer 4 in succession. In this case, the new video information is overwritten on the video information which has been read. Therefore, in buffer 4, video information of an amount corresponding to the predetermined capacity (predetermined time period) is constantly stored.

The analog information read in succession from buffer 4 is converted by A/D converting circuit 6 into digital video information which is then encoded by encoder 8 to be written in a predetermined storage area of HDD 10.

In the reproducing system, writing of new video information and reading of already-written video information are alternately done to/from HDD 10. The read video information is provided to and decoded by decoder 9, and thereafter converted by D/A converting circuit 7 into analog video information which is then provided to buffer 5 and written to and temporarily stored in buffer 5. Buffer 5 also has a predetermined capacity. Therefore, when an amount of information to be output to output unit 2 has been stored in buffer 5, the stored video information is read in succession in the order of being written. The analog video information read from buffer 5 is provided through AVSW 3 to output unit 2, and then output as an image from output unit 2. The above operation is carried out in the reproducing system.

Control of the writing and reading of data to/from buffers 4 and 5 and HDD 10, including addressing, is done according to commands given from CPU 11.

In this way, live video information from a live broadcast that is input from input unit 1 is recorded in a recording medium like buffer 4 or HDD 10 and thereafter read from the recording medium to be output (reproduced) via output unit 2, and this operation is referred to as live reproduction in this embodiment.

In this embodiment, when the live reproduction is being done, video information which is not passed through HDD 10 is output to output unit 2, on a predetermined condition, by the switching function of AVSW 3. Accordingly, the time delay encountered by the conventional art as described above can be avoided. Accordingly, an image which is output from output unit 2 is in real time with respect to an image of video information input from input unit 1. Moreover, since any loss in information amount or any noise occurring in the process through HDD 10 can be avoided, a reproduced image of good quality can be presented.

By the video recording/reproducing apparatus, video information recorded on HDD 10 can be read to be output (reproduced) as an image from output unit 2. Accordingly, when a user does, for a current live reproduction, a pause and a rewind as well as cancellations thereof in order to resume an immediately preceding live reproduction, the user can give an instruction therefor via remote control 14 to the video recording/reproducing apparatus. A signal for this instruction is modulated by means of infrared radiation for example to be received via remote control I/F 15, and the received signal is then analyzed by CPU 11 and commands based on the instruction are provided to proper components. The rewind refers to an operation of moving a read point on the disk backward.

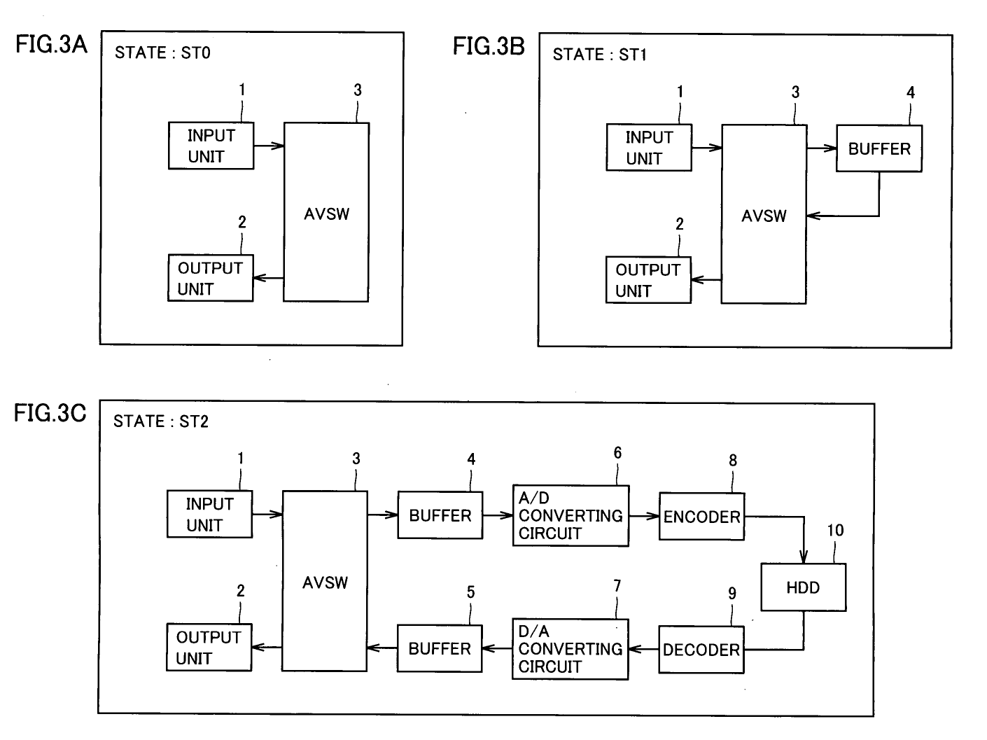

The video recording/reproducing apparatus shown in FIG. 1 has three paths along which video information is transmitted to be output to output unit 2, as shown specifically in FIGS. 3A-3C by states ST0, ST1 and ST2 respectively, and one of the three paths is appropriately set. As shown in FIG. 1, AVSW 3 receives a video information set which is output from input unit 1, a video information set which is read from buffer 4 and a video information set which is read from HDD 10 and output via buffer 5, and selectively outputs one of the input video information sets to output unit 2. In order to accomplish this, CPU 11 gives a switch command concerning the input video information sets to AVSW 3. By a switching operation by AVSW 3 following the switch command from CPU 11, the video recording/reproducing apparatus selectively sets one of states ST0-ST2 in relation to AVSW 3.

More specifically, if the video recording/reproducing apparatus is powered so that analog video information is output from input unit 1 and accordingly AVSW 3 switches to set state ST0, the video information which is output from input unit 1 is provided to output unit 2 via AVSW 3 as shown in FIG. 3A.

If the video recording/reproducing apparatus is powered so that analog video information is output from input unit 1 as well and accordingly AVSW 3 switches to set state ST1, the video information which is output from input unit 1 is written via AVSW 3 to buffer 4, immediately thereafter read from buffer 4 and provided to output unit 2 via AVSW 3 as shown in FIG. 3B.

Further, if the video recording/reproducing apparatus is powered so that analog video information is output from input unit 1 as well and accordingly AVSW 3 switches to set state ST2, the video information which is output from input unit 1 is thereafter passed through AVSW 3, buffer 4, A/D converting circuit 6, encoder 8, HDD 10, decoder 9, D/A converting circuit 7, buffer 5 and AVSW 3 and then provided to output unit 2 as shown in FIG. 3C.

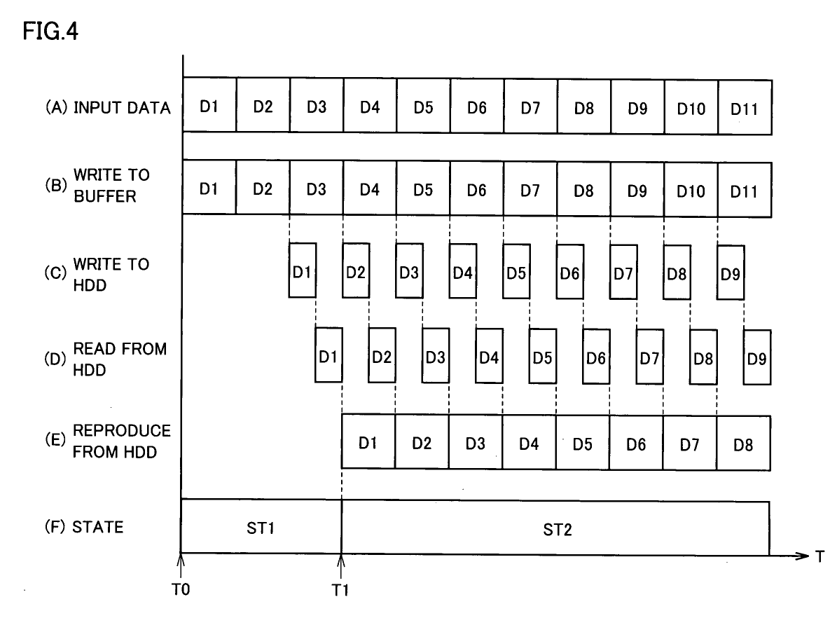

Referring to the timing chart shown in FIG. 4, a description is given of a switch of the state of the video recording/reproducing apparatus according to switching of AVSW 3 with the passage of time T. For the purpose of facilitating the description, it is supposed here that video information is processed on the basis of data Di (i=1, 2, 3, . . . 11) that are successively input in time series order.

As indicated by (A) in FIG. 4, data Di are successively input via input unit 1 with the passage of time T. Then, the input data Di are written to buffer 4 and temporarily stored therein as indicated by (B) in FIG. 4. It is supposed here that buffer 4 can temporarily store only data units Di, Di+1 and Di+2 corresponding to a predetermined capacity of the buffer. Data Di that are temporarily stored in buffer 4 are thereafter read in the order of being written (input) and written to HDD 10 as indicated by (C) in FIG. 4. Here, when writing of a data unit D3 to buffer 4 is started, a data unit D1 is read from buffer 4 to be written to HDD 10. Since HDD 10 is relatively slower in terms of writing and reading speeds than buffer 4, in the period in which one data unit of data Di is written to buffer 4, data of a smaller amount than one data unit of data Di can be written to HDD 10.

Data Di are thus written to HDD 10 and the written data Di are read from HDD 10 in the order of being written (input) as indicated by (D) in FIG. 4 and then provided to decoder 9. Accordingly, to output unit 2, data Di are output after a predetermined time delay with respect to input data Di (see (A) in FIG. 4) as indicated by (E) in FIG. 4.

It is supposed here that, at a certain timing in the period from time T0 to time T1, a live reproduction is started. Since input data units D1-D3 indicated by (A) in FIG. 4 are still stored in buffer 4, AVSW 3 is switched so that the video recording/reproducing apparatus is set to state ST1 (see (F) in FIG. 4), and data Di read from buffer 4 are provided to output unit 2.

If a live reproduction is started after time T1, input data unit D1 indicated by (A) in FIG. 4 is no longer stored in buffer 4 and now is written to HDD 10. Then, AVSW 3 is switched so that the video recording/reproducing apparatus is set to state ST2 (see (F) in FIG. 4) and data Di are read from HDD 10 successively from data D1 as indicated by (D) in FIG. 4 and provided to output unit 2.

If a live reproduction in process is paused at time T0 and the pause is cancelled before time T1 for resuming the live reproduction, data Di that are input in the pause period are still stored in buffer 4. Then AVSW 3 is switched so that the video recording/reproducing apparatus is set to state ST1 and the input data Di that are input in the pause period are read from buffer 4 and provided to output unit 2.

Here, if the pause is cancelled after time T1 for resuming the live reproduction, input data Di that are input in the pause period are no more stored in buffer 4 (overwritten by new input data Di) and are written to HDD 10. Then, AVSW 3 is switched so that the video recording/reproducing apparatus is set to state ST2, and data Di (in the pause period) for the live reproduction resumed after being paused are read from HDD 10 and provided to output unit 2.

It is then supposed that a rewind is done in a live reproduction. If the rewind is done at time T0 and thereafter the live reproduction is resumed in the period from time T0 to time T1, data Di in the rewind period are still in buffer 4 and accordingly AVSW 3 is switched so that the video recording/reproducing apparatus is set to state ST1. The input data Di in the rewind period are thus read from buffer 4 and provided to output unit 2.

Here, if a rewind is done at time T0 and thereafter the live reproduction is resumed after time T1, data in buffer 4 are written to HDD 10 in the rewind period. Then, AVSW 3 is switched so that the video recording/reproducing apparatus is set to state ST2 and the data Di in the rewind period are read from HDD 10 and provided to output unit 2.

The determination as to whether data Di to be reproduced should be read from buffer 4 or HDD 10 is made by CPU 11. CPU 11 outputs a command according to the result of the determination in order to control switching of AVSW 3. The state of the video recording/reproducing apparatus is thus switched.

The operation of switching the state is described below with reference to the flowchart in FIG. 2. When the video recording/reproducing apparatus is powered off, AVSW 3 is switched so that the video recording/reproducing apparatus is set to state ST0 shown in FIG. 3A (step S (hereinafter simply S) 1). The apparatus is thereafter powered on (S2) and then input data Di are provided to the circuits subsequent to AVSW 3 for the purpose of performing a live reproduction or time-shifting function, and recording of input data Di in/on buffer 4 or HDD 10 is started (S3). So far, the apparatus remains in state ST0 and thus data Di that are input from input unit 1 are provided to output unit 2 via AVSW 3 only.

After this, CPU 11 determines whether or not the current operation is a live reproduction which is resumed after a rewind or a pause, namely, whether the time difference is zero in terms of time series between data Di to be reproduced now and data Di that are input successively (whether or not delay is 0 second) (S4). If CPU 11 determines that the time difference is zero (delay=0 second) (YES in S4), CPU 11 switches AVSW 3 so that the video recording/reproducing apparatus is set to state ST1 shown in FIG. 3B (S5). Accordingly, data provided to output unit 2 is the one which is read from buffer 4 immediately after being written to buffer 4. Thus, the data has no delay as compared with data read from HDD 10. Further, there arises no signal loss that occurs when the signal is passed through circuits for being recorded/reproduced on/from HDD 10. An image of good quality is thus reproduced to be output. Thereafter, the operation returns to S4.

If CPU 11 determines that the time difference is not zero (NO in S4), CPU 11 then determines whether data Di to be reproduced now, namely data Di that are input in the pause period have already been written to HDD 10. In other words, CPU 11 uses an internal timer (not shown) to determine whether data Di to be reproduced now are larger than data corresponding to a predetermined period (e.g. three seconds) that are stored temporarily in buffer 4 (S6). If it is determined that the data to be reproduced now exceed the data corresponding to the predetermined period (YES in S6), CPU 11 switches AVSW 3 so that video recording/reproducing apparatus is set to state ST2 (S7). Accordingly, data Di to be reproduced now are read from HDD 10 and undergo signal processing by circuits in subsequent stages and then provided to output unit 2 via AVSW 3. After this, the operation returns to S4.

If CPU 11 determines that data Di to be reproduced now are smaller than the data corresponding to the predetermined period (NO in S6), this means that data Di to be reproduced now are still stored in buffer 4 (have not been overwritten by new input data Di). Thus, CPU 11 switches AVSW 3 so that the video recording/reproducing apparatus is set to state ST1. After this, the operation returns to S4.

In this way, when the live reproduction is done, AVSW 3 is switched to set the video recording/reproducing apparatus to state ST1. Accordingly, an image based on video information which has not been passed through HDD 10 can be presented via output unit 2. Thus, a good-quality image can be obtained and a time delay of output data with respect to input data can be prevented.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A video recording/reproducing apparatus comprising:
a recording system for inputting information including at least a video and recording and accumulating the input information in a recording unit; and
a reproducing system for reading said information in the order of input from said recording unit for the purpose of reproducing said information, wherein
said recording system includes temporary recording means for temporarily recording said input information before said recording unit records said input information, and said information recorded by said temporary recording means is read therefrom to be recorded in said recording unit, and
if said information to be reproduced is recorded in said temporary recording means, said reproducing system reads said information to be reproduced from said temporary recording means instead of said recording unit.

2. The video recording/reproducing apparatus according to claim 1, wherein
said reproducing system includes
switch means for selecting and outputting, as said information to be reproduced, one of said information read from said temporary recording means and said information read from said recording unit, and
determination means for determining whether said information to be reproduced is recorded in said temporary recording means or said recording unit, and
said switch means selects and outputs said information read from said temporary recording means if said determination means determines that said information to be reproduced is recorded in said temporary recording means, and said switch means selects and outputs said information read from said recording unit if said determination means determines that said information to be reproduced is recorded in said recording unit.

3. The video recording/reproducing apparatus according to claim 2, wherein
said determination means determines that said information to be reproduced is recorded in said temporary recording means if there is no time difference between said information to be reproduced and said input information.

4. The video recording/reproducing apparatus according to claim 3, wherein
said determination means determines that said information to be reproduced is recorded in said recording unit if there is at least a predetermined time difference between said information to be reproduced and said input information and determines that said information to be reproduced is recorded in said temporary recording means if there is less than the predetermined time difference between said information to be reproduced and said input information.

5. The video recording/reproducing apparatus according to claim 4, wherein
said temporary recording means has a recording capacity corresponding to an information amount corresponding to said predetermined time difference.

6. The video recording/reproducing apparatus according to claim 4, wherein
said reproducing system further includes resume means for resuming, after a reproduction is paused, the reproduction by canceling pausing of the reproduction, and
said predetermined time difference corresponds to a time period in which the reproduction is paused.

7. The video recording/reproducing apparatus according to claim 4, wherein
said reproducing system further includes resume means for resuming, after a rewind is done in a reproduction, the reproduction by canceling the rewind, and
said predetermined time difference corresponds to a time period of information for which the rewind is done.

8. The video recording/reproducing apparatus according to claim 4, wherein
said predetermined time difference corresponds to a time period in which said information is temporarily recorded in said temporary recording means.

9. The video recording/reproducing apparatus according to claim 8, wherein
said temporary recording means has a recording capacity corresponding to an information amount corresponding to said predetermined time difference.

10. The video recording/reproducing apparatus according to claim 9, wherein
said reproducing system further includes resume means for resuming, after a reproduction is paused, the reproduction by canceling pausing of the reproduction, and
said predetermined time difference corresponds to a time period in which the reproduction is paused.

11. The video recording/reproducing apparatus according to claim 10, wherein
said reproducing system further includes resume means for resuming, after a rewind is done in a reproduction, the reproduction by canceling the rewind, and
said predetermined time difference corresponds to a time period of information for which the rewind is done.

12. The video recording/reproducing apparatus according to claim 11, wherein
said input information including the video is information based on a received live broadcast.

13. The video recording/reproducing apparatus according to claim 2, wherein
said determination means determines that said information to be reproduced is recorded in said recording unit if there is at least a predetermined time difference between said information to be reproduced and said input information and determines that said information to be reproduced is recorded in said temporary recording means if there is less than the predetermined time difference between said information to be reproduced and said input information.

14. The video recording/reproducing apparatus according to claim 13, wherein
said temporary recording means has a recording capacity corresponding to an information amount corresponding to said predetermined time difference.

15. The video recording/reproducing apparatus according to claim 13, wherein
said reproducing system further includes resume means for resuming, after a reproduction is paused, the reproduction by canceling pausing of the reproduction, and
said predetermined time difference corresponds to a time period in which the reproduction is paused.

16. The video recording/reproducing apparatus according to claim 13, wherein
said reproducing system further includes resume means for resuming, after a rewind is done in a reproduction, the reproduction by canceling the rewind, and
said predetermined time difference corresponds to a time period of information for which the rewind is done.

17. The video recording/reproducing apparatus according to claim 13, wherein
said predetermined time difference corresponds to a time period in which said information is temporarily recorded in said temporary recording means.

18. The video recording/reproducing apparatus according to claim 17, wherein
said temporary recording means has a recording capacity corresponding to an information amount corresponding to said predetermined time difference.

19. The video recording/reproducing apparatus according to claim 18, wherein
said reproducing system further includes resume means for resuming, after a reproduction is paused, the reproduction by canceling pausing of the reproduction, and
said predetermined time difference corresponds to a time period in which the reproduction is paused.

20. The video recording/reproducing apparatus according to claim 19, wherein
said reproducing system further includes resume means for resuming, after a rewind is done in a reproduction, the reproduction by canceling the rewind, and
said predetermined time difference corresponds to a time period of information for which the rewind is done.

21. The video recording/reproducing apparatus according to claim 20, wherein
said input information including the video is information based on a received live broadcast.
